(19) United States
(12) Patent Application Publication
(10) Pub. No.: US 2021/0046684 A1
(43) Pub. Date: Feb. 18, 2021

(54) COMPACT CLAMP APPARATUS WITH INTEGRAL HIGH FORCE MOLD BREAK ACTUATOR

(71) Applicant: Niigon Machines Ltd., Vaughan (CA)

(72) Inventors: Robert D. Schad, Toronto (CA); Hemant Kumar, Brampton (CA); Calin Pavel, Kitchener (CA); Carsten Link, Burlington (CA); Marc Ricke, Guelph (CA)

(73) Assignee: Niigon Machines Ltd., Vaughan (CA)

(21) Appl. No.: 17/061,905

(22) Filed: Oct. 2, 2020

Related U.S. Application Data
(63) Continuation of application No. PCT/CA2019/050143, filed on Apr. 4, 2019.
(60) Provisional application No. 62/652,461, filed on Apr. 4, 2018.

(51) Int. Cl. B29C 45/64; B29C 45/68

(52) U.S. Cl. CPC B29C 45/641; B29C 45/68

(57) ABSTRACT

A clamp assembly for an injection molding machine includes a clamp piston slidable within a housing among a clamping position, a mold break position, and a meshing position disposed axially intermediate the clamping and the mold break positions. A clamp chamber urges the clamp piston towards the clamping position when pressurized, and a return device urges the clamp piston from the clamping position to the meshing position when pressure in the clamp chamber is relieved. At least one mold break actuator is coupled to a mold break engagement surface disposed within the housing. The mold break actuator is adjustable to accommodate retraction of mold break surface when the clamp piston moves to the clamping position, and to forcefully push the mold break surface forward against the clamp piston when moving the clamp piston to the mold break position.

This application is a continuation of International Application Serial No. PCT/CA2019/050413, filed Apr. 4, 2019, which claims the benefit of Provisional Application Ser. No. 62/652,461, filed Apr. 4, 2018, which is hereby incorporated herein by reference.

### FIELD

The specification relates to injection molding machines, elements thereof, and methods and apparatuses for controlling motion of molds in an injection molding machine.

### BACKGROUND

U.S. Pat. No. 4,874,309 (Mitsubishi) purports to disclose in a die clamping apparatus including a fixed die plate, a movable die plate, a device for moving the movable die plate relative to the fixed die plate, a device for fixedly coupling the fixed die plate with the movable die plate and tie bars for carrying out clamping of dies, the tie bars are fixedly secured to the fixed die plate and a hydraulic cylinder having a ram is provided on the movable die plate, or vice versa. The coupling device has a half-nut provided on the surface of the fixed die plate so as to be movable in the axial direction of the tie bar insert hole, and are provided on the outer circumference of the tip end of the tie bar and are adapted to mesh with the half-nut. A stopper is provided between the fixed die plate and the half-nut. A part of the ram is made to butt against the stopper to position the ram in the axial direction of the tie bar insert hole. The end surface of the half-nut opposed to the ram is brought into pressing contact with the ram. At that position, the half-nut can be positioned so as to mate with the threads on the tie bar.

U.S. Pat. No. 5,320,517 (Hirata) purports to disclose a clamping apparatus of molding machine including a base; a fixed board disposed on the base; a movable board movable relative to the fixed board; a plurality of mold clamping cylinders disposed in predetermined positions of the fixed board, the mold clamping cylinders each having a mold clamping piston with a tie bar reception hole and a tie bar connection device disposed on the mold clamping piston; a plurality of tie bars with a thread at their one end, the tie bars being disposed in correspondence with the mold clamping cylinders on the movable board; a plurality of mold opening/closing cylinders for moving the movable board; and an axially movable sleeve associated with each clamping cylinder for adjusting an axial position of an associated piston to adjust an engagement position of the tie bar connection device, the sleeve being disposed in an opening in the fixed board and forming an extension of the tie bar reception hole, with one end of the sleeve abutting against a reception wall provided in each piston surrounding the tie bar reception hole and the other end of the sleeve threadedly cooperating with an engagement adjustment screw ring secured to the fixed board.

U.S. Pat. No. 7,981,334 (Chiang) purports to disclose an injection molding machine and a method for mold-adjusting are provided. The injection molding machine comprises a mold-adjusting mechanism mounted to one side of the fixed platen and being coaxial with the tie bars. Each of the mold-adjusting mechanisms is constructed the same comprising a support frame (11), a motor (12), a mold-adjusting driving wheel (13), a mold-adjusting driven wheel (14), a hydraulic cylinder for positioning (15), a sensor and a control system.

U.S. Pat. No. 7,611,346 (Schad et al.) discloses a clamp actuator of a molding system that includes a first actuator configured to be interactable with a rod; and a second actuator configured to be interactable with the first actuator. The first actuator is configured to apply a clamping force to the rod; and the second actuator is configured to apply a force opposing the clamping force to the first actuator. Responsive to actuating the first actuator, the rod is drivable between (i) a home position in which a clamping force is not applicable to the rod, and (ii) a force application position in which the clamping force is applicable to the rod. Responsive to a mold flash occurring which exceeds the clamping force, the rod is moveable into a mold flash position beyond the home position.

WO2014/183201A1 (Schad et al.) discloses a clamp assembly for an injection molding machine that includes: (a) a cylinder housing having an inner end and an outer end spaced axially apart from the inner end; (b) a piston assembly comprising a tie bar end portion of a tie bar and a piston head affixed to the tie bar end portion, the piston assembly slidable within the housing between a meshing position and a clamped position spaced axially apart from the meshing position; (c) a clamp chamber between the piston head and the inner end of the cyl-inder housing for holding pressurized fluid and urging the piston assembly to the clamped position when pressurized; and (d) a spring return device adjacent the outer end of the cylinder housing, the spring return device pushing the piston assembly from the clamped position back to the meshing position when pressure in the clamp chamber is relieved.

WO2016/077927A1 (Link et al.) discloses a clamp assembly for an injection molding machine that includes (a) a clamp cylinder housing and (b) a clamp piston affixed to an end portion of a tie bar and slidable within the housing among a clamping position, a mold break position, and a meshing position disposed axially intermediate the clamping and the mold break positions. The clamp assembly further includes (c) a clamp chamber for urging the clamp piston towards the clamping position when pressurized; (d) a return device for urging the clamp piston towards the meshing position when pressure in the clamp chamber is relieved; and (e) a mold break chamber for urging the clamp piston towards the mold break position when pressurized. The mold break chamber is bounded axially by opposed surfaces of the tie bar and the return device.

### SUMMARY

The following summary is intended to introduce the reader to various aspects of the applicant's teaching, but not to define any invention. In general, disclosed herein are one or more methods or apparatuses related to injection molding, and to closing, clamping, and opening a mold of an injection molding machine.

According to some aspects of the teaching disclosed herein, a clamp assembly for an injection molding machine includes: (a) a housing having a housing inner end and a housing outer end spaced axially apart from the housing inner end along a clamp axis; (b) a clamp piston comprising a piston head affixed to an end portion of a tie bar, the clamp piston slidable within the housing among a clamping position proximate the housing outer end, a mold break position proximate the housing inner end, and a meshing position disposed axially intermediate the clamping and the mold break positions; (c) a clamp chamber axially intermediate the piston head and the housing inner end for urging the clamp piston towards the clamping position when pressurized; (d) a return device comprising a return device engagement surface disposed within the housing and axially intermediate the piston head and the housing outer end for urging the clamp piston from the clamping position to the meshing position when pressure in the clamp chamber is relieved; and (e) at least one mold break actuator adjacent the clamp piston for pushing the clamp piston from the meshing position to the mold break position to urge apart two mold halves clamped together by the tie bar, the mold break actuator comprising a mold break engagement surface disposed within the housing axially intermediate the clamp piston and the housing outer end, the mold break actuator adjustable to accommodate movement of the mold break engagement surface toward a mold break retracted position when the clamp piston moves from the meshing position to the clamping position, and to urge movement of the mold break engagement surface toward a mold break advanced position for pushing the clamp piston from the meshing position to the mold break position.

In some examples, the mold break actuator further comprises a mold break piston coupled to the mold break engagement surface and slidably received in a mold break cylinder, and a mold break chamber inside the mold break cylinder for urging the mold break engagement surface toward the mold break advanced position when pressurized. In some examples, the mold break chamber extends axially between a back face of the mold break piston and an opposed bottom face of the mold break cylinder. In some examples, the bottom face of the mold break cylinder is fixed relative to the housing outer end.

In some examples, the mold break piston is axially slidable independently of the clamp piston. In some examples, the mold break piston is axially slidable independently of the return device.

In some examples, the clamp piston comprises a lock plate having an inner surface directed toward the housing inner end and an outer surface directed toward the housing outer end, a portion of the outer surface of the lock plate comprising a mold break abutment surface, the mold break engagement surface bearing against the mold break abutment surface when pushing the clamp piston toward the inner end of the housing.

In some examples, the housing comprises a housing first portion and a housing second portion. The housing first portion is formed at least partially within the first platen and comprising the housing inner end and an intermediate opening spaced apart from the housing inner end, the intermediate opening for receiving the piston head into the housing first portion; and the housing second portion includes an end cap releasably mounted to the first platen for closing off the intermediate opening, the end cap comprising the housing outer end, and the end cap including the mold break cylinder and the mold break piston slidably received therein of each of the at least one mold break actuators.

In some examples, each of the at least one mold break actuators is assembled to the end cap and removably mounted to the first platen with the end cap. In some examples, the return device comprises a plunger translatable along the clamp axis between plunger advanced and plunger retracted positions, and a plurality of springs captive between the plunger and the end cap, the springs urging the plunger to the plunger advanced position in which a catch surface fixed to the plunger bears against a stop surface fixed to the housing second portion.

In some examples, wherein the plunger includes a non-rotatable plunger collar and a plunger core in rotatable threaded engagement with the plunger collar, the catch surface fixed to the plunger collar, the return device engagement surface fixed to the plunger core, and the plunger core rotatable relative to the plunger collar for adjusting the axial position of the clamp piston when in the meshing position to accommodate changes in mold height.

In some examples, the plunger core of each return device is rotationally fixed and axially slidable relative to an actuating shaft, and each actuating shaft is coupled to a respective position control motor for rotating the plunger core. In some examples, the end cap comprises a motor mounting surface exterior to the outer end of the housing, the position control motor mounted to the motor mounting surface, and the motor mounting surface disposed axially intermediate a bottom face of the mold break chamber and the stop surface. In some examples, the plunger collar has a respective opening in alignment with each of the at least one mold break pistons, the mold break piston slidably passing through the respective opening.

In some examples, the return device abutment surface bears against the return device engagement surface when the clamp piston moves from the meshing position to the clamping position, and wherein the return device engagement surface bears against the return device abutment surface when the clamp piston moves from the clamping position to the meshing position. In some examples, a gap is provided between the mold break engagement surface and the clamp piston when the clamp piston is pushed to the meshing position by the return device.

In some examples, when the clamp piston is in the clamping position, the mold break engagement surface is spaced axially apart from the clamp piston and the return device engagement surface bears against the clamp piston, and when the clamp piston is in the mold break position, the mold break engagement surface bears against the clamp piston and the return device engagement surface is spaced axially apart from the clamp piston.

In some examples, the clamp assembly includes a plurality of the mold break actuators, the mold break pistons of the four actuators spaced circumferentially apart generally equally about the clamp axis. In some examples, the plurality of mold break actuators is four mold break actuators.

According to some aspects, an injection molding machine includes: (a) a machine base; (b) a first platen mounted on the machine base for supporting a first mold half and a second platen mounted to the machine base for supporting a second mold half, the second platen translatable along the machine base toward and away from the first platen for moving the mold halves between a mold closed and a mold open position; (c) a plurality of tie bars extending between the first and second for exerting a clamp force across the mold halves when in the mold closed position; and (d) a clamp assembly associated with each tie bar. Each clamp assembly includes (i) a housing having a housing inner and a housing outer end spaced axially apart from the housing inner end along a clamp axis; (ii) a clamp piston comprising a piston head affixed to an end portion of the respective tie bar, the clamp piston slidable along a clamp axis within the housing among a clamping position proximate the housing outer end, a mold break position proximate the housing inner end, and a meshing position disposed axially intermediate the clamping and the mold break positions; (iii) a clamp chamber axially intermediate the piston head and the housing inner end for urging the clamp piston toward the clamping position when pressurized; and (iv) a plurality of mold break actuators adjacent the clamp piston for pushing the clamp piston from the meshing position to the mold break position to urge apart the first and second mold halves. Each mold break actuator includes a mold break engagement surface disposed within the housing axially intermediate the clamp piston and the housing outer end, each mold break actuator adjustable to accommodate movement of the mold break engagement surface toward a mold break retracted position when the clamp piston moves from the meshing position to the clamping position, and to urge movement of the mold break engagement surface toward a mold break advanced position for pushing the clamp piston from the meshing position to the mold break position.

In some examples, the housing has a housing first portion and a housing second portion, the housing first portion formed at least partially within the first platen and comprising the housing inner end and an intermediate opening spaced apart from the housing inner end, the intermediate opening for receiving the piston head, and the housing second portion comprising an end cap releasably mounted to the first platen for closing off the intermediate opening, the end cap comprising the housing outer end.

In some examples, each mold break actuator is coupled to the respective end cap and releasably mounted to the first platen with the end cap. In some examples, each mold break actuator is captively coupled to the respective end cap, so that when the end cap is removed from the first platen, the mold break actuators captively coupled thereto are removed from the machine and remain coupled to the end cap when the end cap is detached from the first platen. In some examples, each mold break actuator comprises a mold break piston slidably received in a respective piston bore of the end cap, and a mold break chamber between the piston and a bottom face of the piston bore for urging the mold break engagement surface to the mold break position when pressurized.

In some examples, each clamp assembly further comprises a return device axially intermediate the piston head and the housing outer end for urging the clamp piston from the clamping position to the meshing position when pressure in the clamp chamber is relieved, the return device of each clamp assembly coupled to the respective end cap and releasably mounted to the first platen with the end cap. In some examples, the return device of each clamp assembly is captively coupled to the end cap, and is removed from the machine and remains coupled to the end cap when the end cap is detached from the first platen. In some examples, the return device comprises a plurality of springs for pushing the return device against the clamp piston when urging the clamp piston from the clamping position to the meshing positon, each spring received in a respective spring bore of the end cap. In some examples, the piston bores are spaced circumferentially apart from each other about the clamp axis, and the spring bores are circumferentially interspersed between the first bores.

According to some aspects, a method of opening a mold in an injection molding machine includes: (a) relieving pressure in a clamp chamber provided in a first platen, after the clamp chamber has been pressurized to urge a clamp piston affixed to a tie bar towards a clamping position, the tie bar coupled to a second platen by a lock assembly releasably held in a locked position; (b) urging a return device engagement surface of a return device toward the clamp piston to bear against and push the clamp piston from the clamping position to a meshing position when said pressure in the clamp chamber is relieved, the return device engagement surface translating axially relative to a mold break piston, and the mold break piston remaining stationary relative to the housing when the clamp piston is moved from the clamping positon to the meshing position; (c) moving the lock assembly from the locked position to an unlocked position for decoupling the tie bar from the second platen; and (d) energizing a mold stroke actuator to translate the second platen relative to the tie bar and away from the first platen to open the mold.

In some examples, the method further includes a step of determining to apply a mold break force via the mold break piston to forcefully push apart the first and second platens between steps (b) and (c). In some examples, the step of determining to apply a mold break force includes at least one of (i) determining that a mold flash condition exits after step (b); (ii) determining that the geometry of an article being produced by the injection molding machine requires a mold break force, and (iii) determining that a mold opening force exerted by the mold stroke actuator is insufficient to separate a first mold half mounted to the first platen from a second mold half mounted to the second platen.

In some examples, applying the mold break force comprises pressurizing a mold break chamber to urge the mold break piston toward the clamp piston, the mold break piston bearing against and pushing the clamp piston from the meshing position to a mold break position, and urging the second platen away from the first platen. In some examples, during pushing the clamp piston, the mold break piston moves relative to the return device engagement surface through an opening in the return device.

In some examples, the method includes determining to not apply a mold break force via the mold break piston for forcefully pushing apart the first and second platens between steps (b) and (c). In some examples, the step of determining to not apply a mold break force includes determining that an opening force exerted by the mold stroke actuator is sufficient to open the mold.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic side elevation view of an example of an injection molding machine according to some aspects of the teaching disclosed herein;

FIG. 2 is a perspective view of a portion of the machine of FIG. 1;

FIG. 3 is an enlarged cross-sectional view of the clamp assembly structure of FIG. 1, shown in a first condition generally corresponding to a meshing position;

FIG. 4 is an enlarged cross-sectional view of a portion of the clamp assembly structure of FIG. 2, shown in a second condition generally corresponding to a clamping position;

FIG. 5 is an enlarged cross-sectional view of the clamp assembly structure of FIG. 2, shown in a third condition generally corresponding to a mold break position;

FIG. 6 is an enlarged perspective view of a portion of the clamp assembly structure of FIG. 2; and

FIG. 7 is a cutaway view of the structure of FIG. 6.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

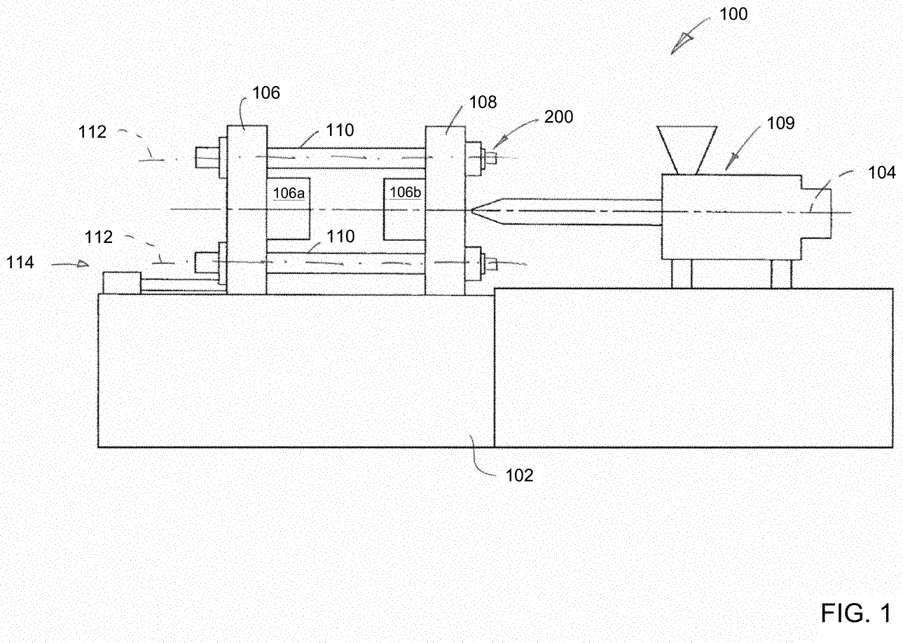

Referring to FIG. 1, an exemplary injection molding machine 100 includes a machine base 102 that extends lengthwise parallel to a machine axis 104. A pair of platens, including a first platen 108 and a second platen 106, are supported by the machine base 102 for carrying respective first and second mold halves 108a, 106a of a mold. An injection unit 109 is also supported by the base 102. At least one tie bar 110 extends generally between the first and second platens 108, 106 for coupling the platens together and exerting a clamp load across the platens when stretched. In the example illustrated, the machine 100 includes four tie bars 110. Each tie bar 110 extends longitudinally along a respective tie bar axis 112.

In the example illustrated, the first platen 108 is also referred to as a stationary platen, and the second platen 106 is also referred to as a moving platen. The second (moving) platen 106 can translate towards and away from the first (stationary) platen 108 along the machine axis 104 to close and open the mold.

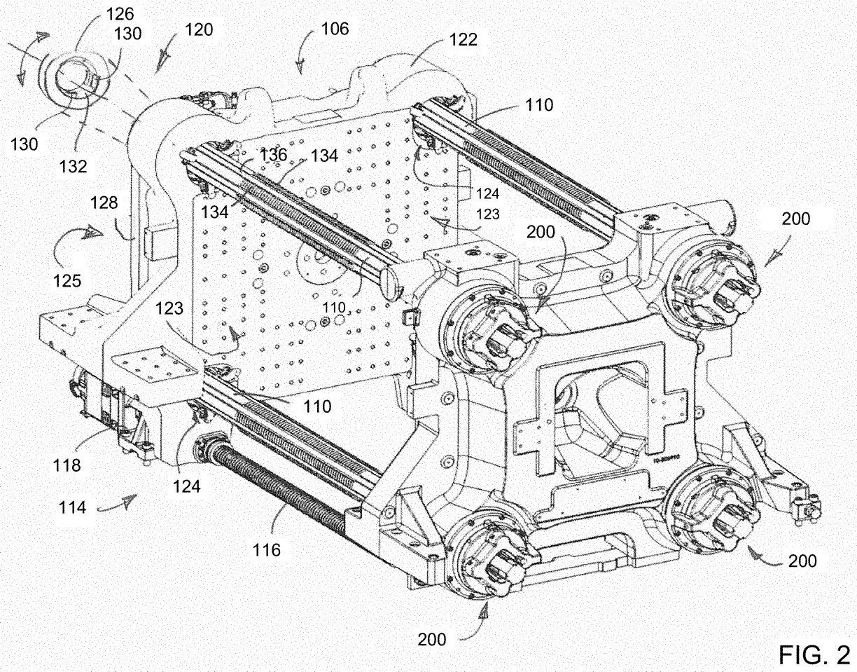

With reference to FIG. 2, a platen actuator 114 can be coupled to the moving platen 106 for advancing and retracting the moving platen 106 between mold-closed and mold-open positions. In the example shown, the platen actuator 114 includes a ball screw 116 driven by an electric motor 118.

Referring to FIG. 2, the machine 100 further includes a lock assembly 120 for releasably coupling the second platen 106 to a respective one of the tie bars 110. In the example illustrated, the machine 100 includes four lock assemblies 120, each mounted to the second platen 106 adjacent a respective tie bar 110.

In the example illustrated, the second platen 106 has a platen body 122 with a mold mounting surface for supporting the second mold half 106a on a front side 123 of the second platen 106 facing the first platen 108. Each lock assembly 120 is mounted to the back side 125 of the second platen 106, proximate a respective tie bar bore 124 passing through the platen body 122. In the example illustrated, the platen body 122 has four tie bar bores 124, each located at a respective corner of the platen body 122 for receiving a respective tie bar therethrough. The bores 124 each extend axially along a lock axis generally aligned with the tie bar axis 112 of the respective tie bar 110.

Each lock assembly 120 includes, in the example illustrated, a rotary lock member 126 mounted within the platen and having longitudinal rows of inwardly directed lock teeth 130, the rows of lock teeth 130 separated from each other by longitudinal clearance grooves 132. Each tie bar 110 is provided with corresponding longitudinal rows of tie bar teeth 134, separated by longitudinal tie bar grooves 136. The lock member 126 is rotatable between an unlocked position, in which each row of lock teeth 130 is aligned with a respective longitudinal tie bar groove 136, and a locked position, in which each row of lock teeth 130 is aligned with a respective row of tie bar teeth 134. When in the locked position, the lock teeth 130 intermesh with the tie bar teeth 134 so that an axial force applied to the tie bar 110 is transferred to the moving platen 106.

To facilitate interference-free movement of the lock member 126 between the locked an unlocked positions, the moving platen can be moved to a predetermined axial position, for example, to a known “mold-closed” position, and the tie bar can similarly be moved to a pre-determined axial position, for example, to a known “meshing position” in which the tie bar teeth 134 are aligned with lock valleys disposed axially between adjacent lock teeth 130, and in which the lock teeth 130 are aligned with tie bar valleys disposed axially between adjacent tie bar teeth 134.

In the example illustrated, the lock member 126 can be rotated between the locked and unlocked positions by a lock actuator 128, which can include, for example, any one or more of fluid cylinders, electrical motors, ball screws, belts, linkage arms, pulleys, and gears.

In the example illustrated, the machine 100 further includes a clamp assembly 200 for applying a clamp load across the mold halves 106a, 108a when in the mold-closed position. In the example illustrated, the machine 100 has four clamp assemblies 200, each associated with a respective tie bar 110.

In the example illustrated, each clamp assembly 200 integrally includes provision for returning the tie bar 110 to the meshing position after clamp-up, as well as provision for mold height adjustment. The clamp assembly 200 further integrally includes provision for optionally exerting a mold break force to urge the mold halves 106a, 108a apart after an injection cycle.

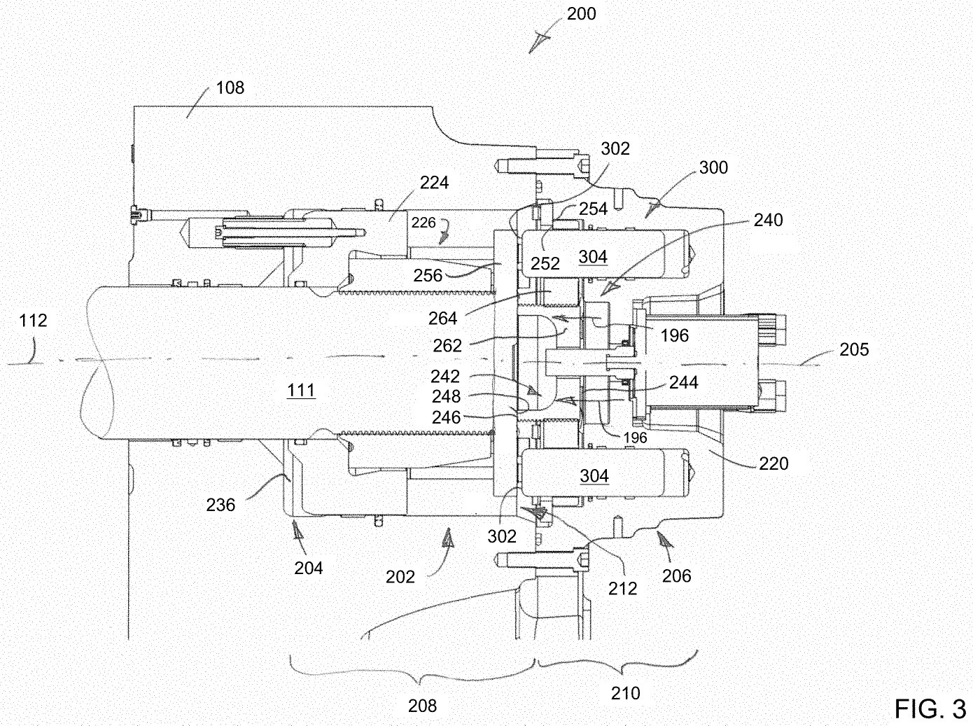

Referring to FIG. 3, each clamp assembly 200 includes a housing 202 having a housing inner end 204 and a housing outer end 206 spaced axially apart from the housing inner end 204 along a clamp axis. The clamp axis is, in the example illustrated, generally aligned with the tie bar axis 112 along the tie bar end portion 111 of the tie bar 110. In the example illustrated, the housing 202 is affixed to the first (stationary) platen 108, and the end portion 111 of the tie bar 110 protrudes through an opening at the housing inner end 204 and is disposed within the housing 202.

In the example illustrated, the housing 202 includes a housing first portion 208 and a housing second portion 210. The housing first portion 208 is, in the example illustrated, formed at least partially within the body of the first platen 108, and includes the housing inner end 204. The housing first portion further includes, in the example illustrated, an intermediate opening 212 spaced axially apart from the housing inner end 204. The intermediate opening receives the piston head 224, for example when installing the piston head 224 into position within the housing 202 and attaching the piston head to the tie bar end portion 111 during assembly. The housing second portion 210 includes an end cap 220 releasably mounted to the first platen 108 for closing off the intermediate opening 212, and the end cap 220 includes the housing outer end 206.

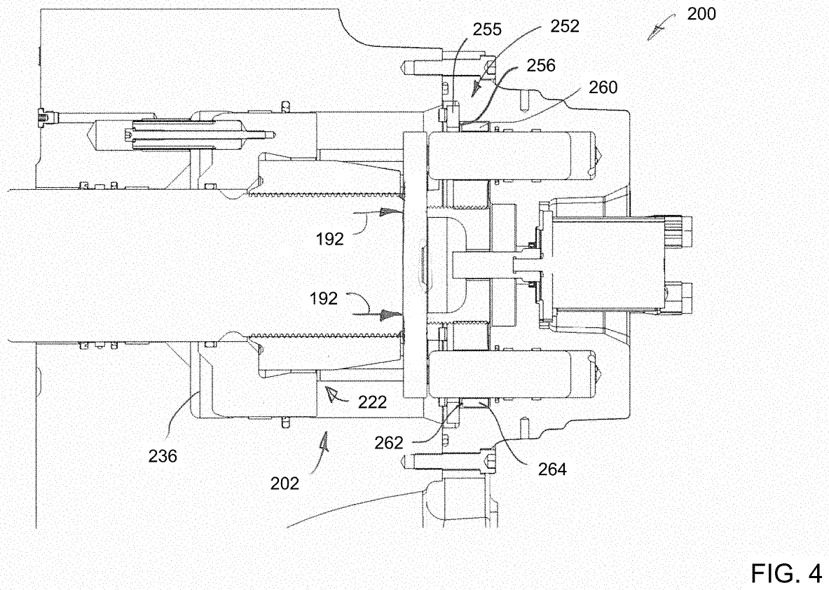

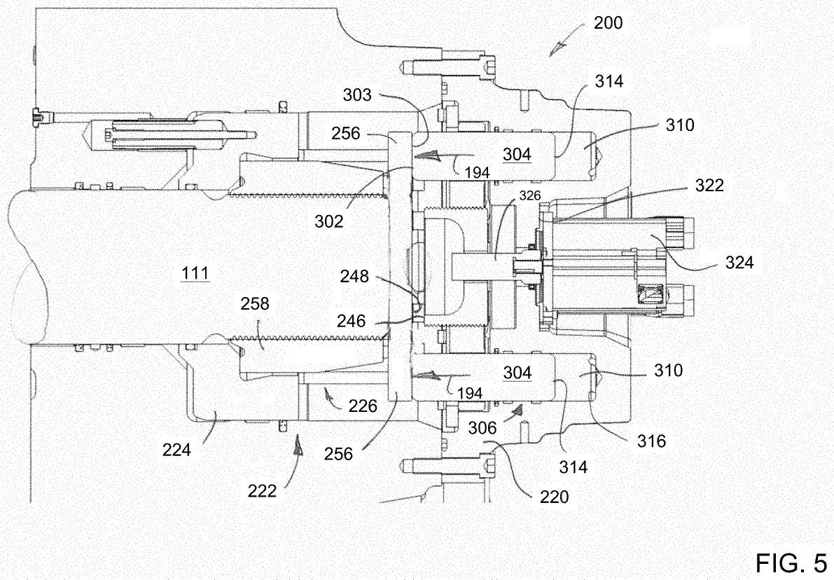

Each clamp assembly 200 further includes a clamp piston 222 that includes a piston head 224 affixed by, for example, a tie bar nut assembly 226, to a tie bar end portion 111 of the tie bar 110 of the machine 100. The clamp piston 222 is slidable within the housing 202 among a clamping position proximate the housing outer end 206 (FIG. 4), a mold break position proximate the housing inner end 204 (FIG. 5), and a meshing position disposed axially intermediate the clamping position and the mold break position (FIG. 3).

Referring to FIG. 3, the meshing position corresponds to a first axial location of the clamp piston 222 (and also the tie bar 110 to which it is affixed) for interference-free movement of the lock member 126 from the unlocked to the locked positions relative to the tie bar teeth 134. Optionally, the lock member 126 can move in the opposite direction, from the locked position to the unlocked position, while the clamp piston 222 is in the meshing position.

Referring to FIG. 4, the clamping position corresponds to a second axial location of the clamp piston 222 spaced axially apart from the first axial location in a clamping direction (i.e. towards the housing outer end 206, in the example illustrated). In the clamping position, a clamp force is exerted via the tie bar 110 across the mold (i.e. mold halves 106a, 108a) of the machine 100 through engagement of the tie bar teeth 134 with the lock teeth 130, and engagement of the lock member 126 against an abutment surface of the second platen 106.

Referring to FIG. 5, the mold break position corresponds to a third axial location of the clamp piston 222 spaced axially apart from the first axial location in an unclamping direction opposite the clamping direction (i.e., towards the housing inner end 204, in the example illustrated) and in which the mold halves 106a, 108a are urged apart by movement of the tie bar 110 (and hence the moving platen 106 locked thereto) in the unclamping direction.

Referring again to FIG. 4, in the example illustrated, the clamp assembly 200 further comprises a clamp chamber 236 within the housing 202 for urging the clamp piston 222 toward the housing outer end 206 when pressurized (in the direction of clamping arrows 192). In the example illustrated, the clamp chamber 236 is disposed axially intermediate the piston head and the housing inner end 204, and urges the clamp piston 222 from the meshing position to the clamping position when pressurized (i.e. when filled with working fluid at a clamping pressure).

The clamp assembly 200 further includes a return device 240 having a return device engagement surface 246 within the housing 202, and axially intermediate the clamp piston 222 and the housing outer end 206. The return device 240 urges the clamp piston 222 from the clamping position to the meshing position when pressure in the clamp chamber 236 is relieved. The clamp piston 222 includes a return device abutment surface 248 for engagement with the return device engagement surface.

In the example illustrated, the return device 240 comprises a plunger 242 translatable along the clamp axis between plunger advanced and plunger retracted positions, and a plurality of springs 244 captive between the plunger 242 and the end cap 220. The return device in the example illustrated includes a plurality of springs 244 spaced generally equally about the clamp axis in a polar (circular) array, and more particularly, includes four springs 244 spaced circumferentially apart from each other by about 90 degrees around the clamp axis.

The springs 244 urge the plunger 242 to the plunger advanced position (direction of return arrows 196 in FIG. 3) in which a catch surface 252 fixed to the plunger 242 bears against a stop surface 254 fixed to the housing second portion 210. In the example illustrated, the catch surface 252 comprises a peripheral portion of the plunger collar 260, and the stop surface 254 comprises a surface of an annular keeper 255 directed towards the catch surface 252.

In the example illustrated, the return device engagement surface 246 comprises an endface of the plunger 242, and the return device abutment surface 248 comprises a portion of the clamp piston 222. More particularly, in the example illustrated, the return device abutment surface 248 comprises an outwardly directed surface of the tie bar nut assembly 226, and more specifically, an outwardly directed surface of a lock plate 256 secured to the tie bar end portion 111 of the clamp piston 222 for fixing a tie bar lock nut 258 (to which the clamp piston 222 is secured) in position relative to the tie bar 110. The return device engagement surface 246 is movable away from the housing outer end 206 to a return device advanced position (FIG. 3) for pushing the clamp piston 222 back to the meshing position when pressure in the clamp chamber 236 is relieved.

In the example illustrated, each spring 244 is received in a spring bore 250 provided in the end cap 220. In the example illustrated, the return device includes four spring bores 250, the spring bores 250 spaced circumferentially apart from each other by about 90 degrees around the clamp axis.

The plunger 242 includes a non-rotatable plunger collar 260 and a plunger core 262 in rotatable threaded engagement with the plunger collar 260. The return device engagement surface 246 is, in the example illustrated, fixed to the plunger core 262, and the catch surface 252 is fixed to the plunger collar 260. The plunger core is rotatable relative to the plunger collar for adjusting the axial position of the clamp piston 222 when in the meshing position to accommodate changes in mold height. Rotation of the plunger core 262 changes the axial position of the return device engagement surface 246 when the plunger 242 is in the advanced position (i.e. when the catch surface 252 abuts the stop surface 254).

The clamp assembly 200 further comprises a mold break mechanism for pushing the clamp piston 222 from the meshing position to the mold break position to urge apart the mold halves 106a, 108a after an injection cycle. The mold break mechanism includes at least one mold break actuator 300 adjacent the clamp piston 222. In the example illustrated, the mold break mechanism includes a plurality of mold break actuators 300 of equivalent design and spaced generally equally about the clamp axis in a polar (circular) array. More particularly, in the example illustrated, the mold break mechanism includes four mold break actuators 300 spaced circumferentially apart from each other by about 90 degrees around the clamp axis.

Each mold break actuator 300 comprises a mold break engagement surface 302 disposed within the housing 202 axially intermediate the clamp piston 222 and the housing outer end 206. The mold break actuator 300 is adjustable to urge movement of the mold break engagement surface 302 toward a mold break advanced position for pushing the clamp piston from the meshing position to the mold break position (in direction of arrows 194 in FIG. 5), and to accommodate movement of the mold break engagement surface 302 toward a mold break retracted position when the clamp piston 222 moves from the meshing position to the clamping position.

The clamp piston 222 includes a mold break abutment surface 303 for engagement with the mold break engagement surface. In the example illustrated, the mold break abutment surface 303 is fixed relative to the piston, and optionally comprises another portion of the lock plate 256, adjacent the return device abutment surface 248.

In the example illustrated, the mold break actuator 300 includes at least one mold break piston 304 coupled to the mold break engagement surface 302 and slidably received in a mold break cylinder 306. In the example illustrated, the mold break piston 304 comprises a piston front endface, and the mold break engagement surface 302 comprises at least a portion of the piston front endface. A mold break chamber 310 is provided inside the mold break cylinder 306 for urging the mold break engagement surface 302 toward the mold break advanced position when pressurized.

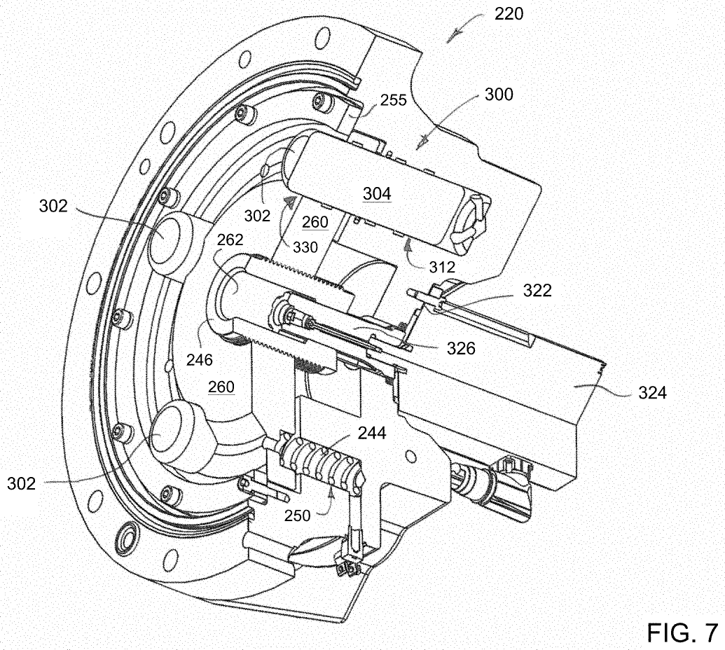

In the example illustrated, each mold break cylinder 306 includes a piston bore 312 provided in the end cap 220. In the example illustrated, the mold break mechanism includes four piston bores 312 arranged in a polar (circular) array about the clamp axis, and spaced circumferentially apart from each other by about 90 degrees around the clamp axis. In the example illustrated, the piston bores 312 are interspersed with the spring bores 250 in the end cap 220, i.e. each piston bore 312 is disposed circumferentially between adjacent spring bores 250 (FIG. 7).

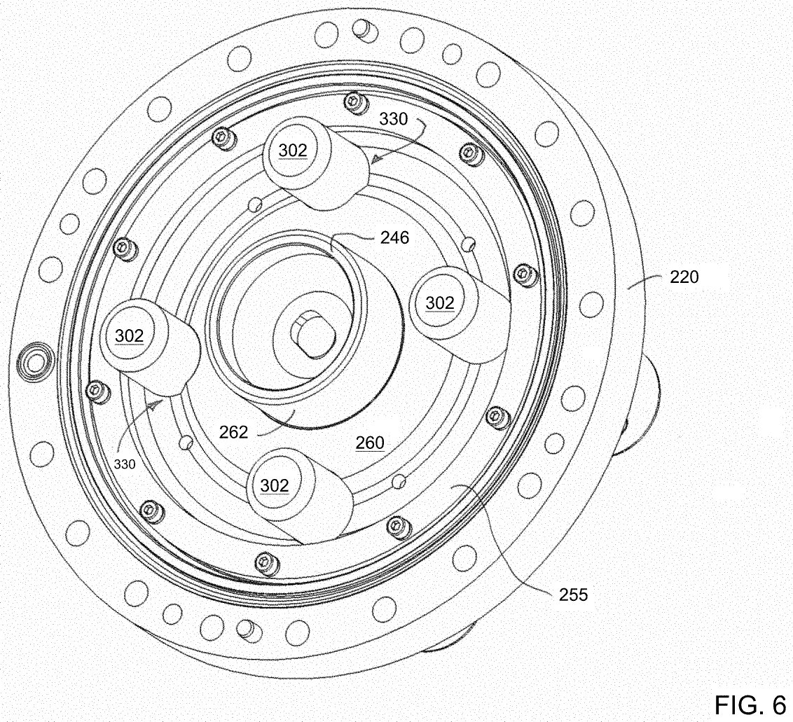

Referring again to FIG. 5, the mold break chamber 310 of each mold break actuator 300 extends axially between a piston back surface 314 of the mold break piston 304 and a bottom face 316 of the piston bore 312. The mold break cylinder 306 is fixed relative to the housing outer end 206, and in the example illustrated, the end cap 220 includes the mold break cylinder 306 and the mold break piston 304 slidably received therein. Each of the at least one mold break actuators 300 is, in the example illustrated, coupled to the end cap 220 and removably mounted to the second platen 106 with the end cap 220 (FIG. 6).

In the example illustrated, the end cap 220 further includes a motor mounting surface 322 exterior to the housing outer end 206 of each clamp assembly 200. A position control motor 324 is mounted to each motor mounting surface 322, and coupled to an actuating shaft 326 extending inside the housing 202. The plunger core 262 of each return device 240 is rotationally fixed and axially slidable to a respective actuating shaft 326 for rotating the plunger core 262 relative to the plunger collar 260. In the example illustrated, the motor mounting surface 322 is disposed axially intermediate the bottom face 316 of the piston bore 312 and the stop surface 254 of the return device 240. This configuration can help to reduce the outward axial extension of the clamp assembly 200 from the first platen 108.

In the example illustrated, the plunger collar 260 of the return device 240 is provided with collar openings 330 (FIG. 7) through which the mold break pistons 304 slidably pass. The collar openings 330 extend axially through the plunger collar 260, and are aligned with the mold break piston bores 312. In the example illustrated, the mold break engagement surface 302 (piston front endface) and the piston back surface 314 protrude axially from opposed sides of the plunger collar 260 when the mold break piston 304 is in and moves between the piston retracted (FIG. 4) and piston advanced (FIG. 5) positions.

In the example illustrated, the mold break piston 304 is axially slidable independently of the clamp piston 222. The mold break piston 304 is, in the example illustrated, axially slidable independently of the return device 240.

Referring to FIG. 3, in use, a clamping cycle can begin with the mold closed (mold halves 106a, 108a abutting) and the clamp piston 222 in the meshing position. The clamp chamber 236 is preferably filled with fluid, but is not subject to clamp pressure. The clamp chamber port may be closed, and any force that may be exerted on the clamp piston 222 in the clamping direction by the fluid in the clamp chamber 236 is less than the force exerted by the springs 244 in the unclamping direction. Thus, the return device 240 remains in the plunger advanced position, and the return device abutment surface 248 (i.e. the tie bar engagement surface, in the example illustrated) remains in abutting engagement against the return device engagement surface 246. The rotary lock members 126 can be moved from the unlocked position to the locked position, with the lock teeth 130 advancing between the tie bar teeth 134 without rubbing against each other, jamming, or otherwise interfering when moving from the unlocked to the locked position.

Referring to FIG. 4, once the lock members 126 are in the locked position, the clamp chamber port can be opened and the clamp chamber 236 can be pressurized to move the clamp piston 222 to the clamping position, compressing the springs 244 in the process. Resin can be injected into the mold while sufficient clamp load is applied across the mold.

Once the injection is complete, the clamp force can be relieved by relieving the pressure in the clamp chamber 236. The return device 240 may then push the clamp piston 222 back to the meshing position, under the force exerted by the springs 244.

If no mold break force is required, for example, if the platen actuator 114 can generate sufficient opening force to pull the moving platen 106 away from the stationary platen 108 after injection, then once the clamp piston 222 has been moved to the meshing position, the lock members 126 may be moved to the unlocked position. The platen stroke actuator 114 (traverse actuator) can then be energized in a reversing direction to open the mold. The molded articles may then be ejected and a subsequent cycle can be initiated.

In some cases, it may be determined that a mold break force should be applied to break the mold halves 106a, 108a apart before the platen actuator 114 opens the mold. This determination may be made because, for example, the mold halves 106a, 108a may have become frozen together, for example as a result of flashing the mold. Another reason for deciding to apply a mold break force may be based on the geometry of the article being molded, for example, where the geometry is known to require a greater force to open the mold. In other cases, it may be determined, for example when setting up a machine for a production run, that a strong opening force greater than that which the platen actuator 114 can provide is required to break the mold open.

In cases where a mold break force is required or desired, the mold break chamber 310 of the clamp assembly 200 is energized to exert a strong opening force (mold break force) in the unclamping direction, while the lock assembly 120 is in the locked position. Pressurized fluid can be fed into the mold break chamber 310 to push the mold break piston 304 forward, against the clamp piston 222. This moves the clamp piston 222 in the unclamping direction, pushing the tie bar 110 and the moving platen 106 locked thereto in the same unclamping direction to open the mold.

After the mold has been broken open, the pressure in the mold break chamber 310 is relieved. The lock member 126 is moved to the unlocked position, and the platen actuator 114 is energized to translate the moving platen 106 away from the stationary platen 108 to open the mold. The clamp chamber 236 is energized to move the clamp piston 222 back to the meshing position, pushing the mold break engagement surface of each of the mold break pistons 304 back to the mold break retracted position.

Various features and advantages of the embodiments described herein are set forth in the following claims.

1. A clamp assembly for an injection molding machine, the clamp assembly comprising:
a) a housing having a housing inner end and a housing outer end spaced axially apart from the housing inner end along a clamp axis;
b) a clamp piston comprising a piston head affixed to an end portion of a tie bar, the clamp piston slidable within the housing among a clamping position proximate the housing outer end, a mold break position proximate the housing inner end, and a meshing position disposed axially intermediate the clamping and the mold break positions;
c) a clamp chamber axially intermediate the piston head and the housing inner end for urging the clamp piston towards the clamping position when pressurized;
d) a return device comprising a return device engagement surface disposed within the housing and axially intermediate the piston head and the housing outer end for urging the clamp piston from the clamping position to the meshing position when pressure in the clamp chamber is relieved; and
e) at least one mold break actuator adjacent the clamp piston for pushing the clamp piston from the meshing position to the mold break position to urge apart two mold halves clamped together by the tie bar, the mold break actuator comprising a mold break engagement surface disposed within the housing axially intermediate the clamp piston and the housing outer end, the mold break actuator adjustable to accommodate movement of the mold break engagement surface toward a mold break retracted position when the clamp piston moves from the meshing position to the clamping position, and to urge movement of the mold break engagement surface toward a mold break advanced position for pushing the clamp piston from the meshing position to the mold break position.

2. The clamp assembly of claim 1, wherein the mold break actuator further comprises a mold break piston coupled to the mold break engagement surface and slidably received in a mold break cylinder, and a mold break chamber inside the mold break cylinder for urging the mold break engagement surface toward the mold break advanced position when pressurized.

3. The clamp assembly of claim 2, wherein the mold break chamber extends axially between a back face of the mold break piston and an opposed endface of the mold break cylinder.

4. The clamp assembly of claim 3, wherein the endface of the mold break cylinder is fixed relative to the housing outer end.

5. The clamp assembly of claim 2, wherein the mold break piston is axially slidable independently of the clamp piston.

6. The clamp assembly of claim 2, wherein the mold break piston is axially slidable independently of the return device.

7. The clamp assembly of claim 2, wherein the clamp piston comprises a lock plate having an inner surface directed toward the housing inner end and an outer surface directed toward the housing outer end, a portion of the outer surface of the lock plate comprising a mold break abutment surface, the mold break engagement surface of the mold break piton bearing against the mold break abutment surface of the lock plate when pushing the clamp piston toward the inner end of the housing.

8. The clamp assembly of claim 2, wherein the housing comprises a housing first portion and a housing second portion;
the housing first portion formed at least partially within the first platen and comprising the housing inner end and an intermediate opening spaced apart from the housing inner end, the intermediate opening for receiving the piston head into the housing first portion; and
the housing second portion comprising an end cap releasably mounted to the first platen for closing off the intermediate opening, the end cap comprising the housing outer end, and the end cap including the mold break cylinder and the mold break piston slidably received therein of each of the at least one mold break actuators.

9. The clamp assembly of claim 8, wherein each of the at least one mold break actuators is assembled to the end cap and removably mounted to the first platen with the end cap.

10. The clamp assembly of claim 8, wherein the return device comprises a plunger translatable along the clamp axis between plunger advanced and plunger retracted positions, and a plurality of springs captive between the plunger and the end cap, the springs urging the plunger to the plunger advanced position in which a catch surface fixed to the plunger bears against a stop surface fixed to the end cap.

11. The clamp assembly of claim 10, wherein the plunger includes a non-rotatable plunger collar and a plunger core in rotatable threaded engagement with the plunger collar, the catch surface fixed to the plunger collar, the return device engagement surface fixed to the plunger core, and the plunger core rotatable relative to the plunger collar for adjusting the axial position of the clamp piston when in the meshing position to accommodate changes in mold height.

12. The clamp assembly of claim 11, wherein the plunger core of each return device is rotationally fixed and axially slidable relative to an actuating shaft, and each actuating shaft is coupled to a respective position control motor for rotating the plunger core.

13. The clamp assembly of claim 11, wherein the plunger collar has a respective opening in alignment with each of the at least one mold break pistons, the mold break piston slidably passing through the respective opening.

14. The clamp assembly of claim 2, wherein when the clamp piston is in the clamping position, the mold break engagement surface is spaced axially apart from the clamp piston and the return device engagement surface bears against the clamp piston, and when the clamp piston is in the mold break position, the mold break engagement surface bears against the clamp piston and the return device engagement surface is spaced axially apart from the clamp piston.

15. The clamp assembly of claim 2, comprising four said mold break actuators, the mold break pistons of the four actuators spaced circumferentially apart generally equally about the clamp axis.

16. An injection molding machine, comprising:
a) a machine base;
b) a first platen mounted on the machine base for supporting a first mold half and a second platen mounted to the machine base for supporting a second mold half, the second platen translatable along the machine base toward and away from the first platen for moving the mold halves between a mold closed and a mold open position;
c) a plurality of tie bars extending between the first and second platens for exerting a clamp force across the mold halves when in the mold closed position;
d) a clamp assembly associated with each tie bar, each clamp assembly including:
i) a housing having a housing inner and a housing outer end spaced axially apart from the housing inner end along a clamp axis;
ii) a clamp piston comprising a piston head affixed to an end portion of the respective tie bar, the clamp piston slidable along a clamp axis within the housing among a clamping position proximate the housing outer end, a mold break position proximate the housing inner end, and a meshing position disposed axially intermediate the clamping and the mold break positions;
iii) a clamp chamber axially intermediate the piston head and the housing inner end for urging the clamp piston toward the clamping position when pressurized; and
iv) a plurality of mold break actuators adjacent the clamp piston for pushing the clamp piston from the meshing position to the mold break position to urge apart the first and second mold halves,
each mold break actuator comprising a mold break engagement surface disposed within the housing axially intermediate the clamp piston and the housing outer end, each mold break actuator adjustable to accommodate movement of the mold break engagement surface toward a mold break retracted position when the clamp piston moves from the meshing position to the clamping position, and to urge movement of the mold break engagement surface toward a mold break advanced position for pushing the clamp piston from the meshing position to the mold break position.

17. The injection molding machine of claim 16, wherein:
a) the housing has a housing first portion and a housing second portion;
b) the housing first portion formed at least partially within the first platen and comprising the housing inner end and an intermediate opening spaced apart from the housing inner end, the intermediate opening for receiving the piston head; and
c) the housing second portion comprising an end cap releasably mounted to the first platen for closing off the intermediate opening, the end cap comprising the housing outer end.

18. The injection molding machine of claim 17, wherein each mold break actuator is coupled to the respective end cap and releasably mounted to the first platen with the end cap.

19. The injection molding machine of claim 18, wherein each mold break actuator comprises a mold break piston slidably received in a respective first bore of the end cap, and a mold break chamber between the piston and the closed end of the first bore for urging the mold break engagement surface to the mold break position when pressurized

20. The injection molding machine of claim 19, wherein each clamp assembly further comprises a return device axially intermediate the piston head and the housing outer end for urging the clamp piston from the clamping position to the meshing position when pressure in the clamp chamber is relieved, the return device of each clamp assembly coupled to the respective end cap and releasably mounted to the first platen with the end cap.

21. The injection molding machine of claim 20, wherein the return device comprises a plurality of springs for pushing the return device against the clamp piston when urging the clamp piston from the clamping position to the meshing positon, each spring received in a respective second bore of the end cap.

22. The injection molding machine of claim 21, wherein the first bores are spaced circumferentially apart from each other about the clamp axis, and the second bores are circumferentially interspersed between the first bores.

23. A method of opening a mold in an injection molding machine, the method comprising:
a) relieving pressure in a clamp chamber provided in a first platen, after the clamp chamber has been pressurized to urge a clamp piston affixed to a tie bar towards a clamping position, the tie bar coupled to a second platen by a lock assembly releasably held in a locked position;
b) urging a return device engagement surface of a return device toward the clamp piston to bear against and push the clamp piston from the clamping position to a meshing position when said pressure in the clamp chamber is relieved, the return device engagement surface translating axially relative to a mold break piston, and the mold break piston remaining stationary relative to the housing when the clamp piston is moved from the clamping positon to the meshing position;
c) moving the lock assembly from the locked position to an unlocked position for decoupling the tie bar from the second platen; and
d) energizing a mold stroke actuator to translate the second platen relative to the tie bar and away from the first platen to open the mold.

24. The method of claim 23, further comprising determining to apply a mold break force via the mold break piston to forcefully push apart the first and second platens between steps (b) and (c).

25. The method of claim 24, wherein the step of determining to apply a mold break force includes at least one of (i) determining that a mold flash condition exits after step (b); (ii) determining that the geometry of an article being produced by the injection molding machine requires a mold break force, and (iii) determining that a mold opening force exerted by the mold stroke actuator is insufficient to separate a first mold half mounted to the first platen from a second mold half mounted to the second platen.

26. The method of claim 25, wherein applying the mold break force comprises pressurizing a mold break chamber to urge the mold break piston toward the clamp piston, the mold break piston bearing against and pushing the clamp piston from the meshing position to a mold break position, and urging the second platen away from the first platen.
